(19) United States
(12) Patent Application Publication
(10) Pub. No.: US 2010/0223100 A1
(43) Pub. Date: Sep. 2, 2010

(54) Methods and Systems for Sales Networking

(75) Inventors: Peter Lee, San Francisco, CA (US); Neeraj Ahuja, Fremont, CA (US); Edward Li, Oakland, CA (US); Gene Rivera, San Francisco, CA (US); David Park, San Francisco, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Salesforce.com, Inc., San Francisco, CA (US)

(21) Appl. No.: 12/693,270

(22) Filed: Jan. 25, 2010

Related U.S. Application Data
(60) Provisional application No. 61/146,972, filed on Jan. 23, 2009.

(51) Int. Cl. G06Q 10/00

(52) U.S. Cl. 705/10

(57) ABSTRACT

Methods and systems for sales networking are provided. A user of a database system can be helped to identify relevant business opportunities from those similar to a selected opportunity. For example, a salesperson can search for similar deals to the one the person is working, contact people who have worked similar deals and ask for their advice, and bookmark those deals to refer back to them as they work the deal. The similar opportunities can be found by matching properties (such as field and related records) of an opportunity record that corresponds to the opportunity of interest.

### CROSS-REFERENCES TO RELATED APPLICATIONS

The present application claims benefit under 35 USC 119(e) of U.S. provisional Application No. 61/146,972, filed on Jan. 23, 2009, entitled “METHODS AND SYSTEMS FOR SALES NETWORKING,” the content of which is incorporated herein by reference in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention generally relates to sales networking, and more particularly to identifying relevant business opportunities, e.g., those similar to a selected opportunity.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

In a large organization, the number of business deals between suppliers, retailers, or any other partners may be quite large. A salesperson working on one deal may not know of other deals that other salespersons have worked on. Thus, knowledge gained from one deal is not used for another deal.

Knowledge of other deals within the organization, especially the deals that have similar characteristics like the current business opportunity, would probably help the salesperson to find ways to close the deal. Unfortunately, there is no available system providing this feature to the salespersons.

Accordingly, it is desirable to provide methods and systems for facilitating the exchange of knowledge regarding opportunities between people (e.g. salespersons), thus overcoming the above and other problems.

### BRIEF SUMMARY

In accordance with embodiments, there are provided methods and systems directed to sales networking, e.g. by helping a user to identify relevant business opportunities from those similar to a selected opportunity. Embodiments can help a salesperson search for similar deals to the one the person is working, contact people who have worked similar deals and ask for their advice, and bookmark those deals to refer back to them as they work the deal.

In an embodiment and by way of example, a method of identifying a similar opportunity is provided. A database system receives, from an organization, data associated with a first business opportunity. A first opportunity record from the data associated with the business opportunity is created in a database of the database system. The first opportunity record has a plurality of properties defined in the database system. The database system receives, from a user of the organization, a request for business opportunities similar to the first business opportunity. The database system identifies one or more similar opportunity records that have one or more matching properties compared to the properties of the first opportunity record. The one or more similar opportunity records are provided to the user.

Systems, computer readable medium, and related apparatuses are also provided.

Reference to the remaining portions of the specification, including the drawings and claims, will realize other features and advantages of the present invention. Further features and advantages of the present invention, as well as the structure and operation of various embodiments of the present invention, are described in detail below with respect to the accompanying drawings. In the drawings, like reference numbers indicate identical or functionally similar elements.

### BRIEF DESCRIPTION OF THE DRAWINGS

In the following drawings like reference numbers are used to refer to like elements. Although the following figures depict various examples of the invention, the invention is not limited to the examples depicted in the figures.

FIG. 1 illustrates a block diagram of an environment wherein an on-demand database service might be used.

FIG. 2 illustrates a block diagram of an embodiment of elements of FIG. 1 and various possible interconnections between these elements according to an embodiment of the present invention.

FIG. 3 is a flowchart of a method 300 of identifying a business opportunity according to an embodiment of the present invention.

FIG. 4 is a flowchart of a method 400 of managing selections for a business opportunity according to an embodiment of the present invention.

FIG. 5 shows a screenshot of an admin page illustrating managing configurations for an opportunity object according to an embodiment of the present invention.

FIG. 6 is a flowchart of a method 600 of identifying a business opportunity according to an embodiment of the present invention.

FIG. 7 shows a screenshot of an opportunity object with a region for similar opportunities list according to an embodiment of the present invention.

FIG. 8 shows a screenshot of a result of a search for similar opportunities according to an embodiment of the present invention.

FIG. 9 shows a screenshot of an opportunity object with a similar opportunities list according to an embodiment of the present invention.

### DETAILED DESCRIPTION

### General Overview

Systems and methods are provided for finding business opportunities similar to a selected business opportunity, and more particularly for finding business opportunities that have matching values to those of the selected opportunity in a set of preselected categories.

As used herein, the term multi-tenant database system refers to those systems in which various elements of hardware and software of the database system may be shared by one or more customers. For example, a given application server (e.g. running an application process) may simultaneously process requests for a great number of customers, and a given database table may store rows for a potentially much greater number of customers. As used herein, the term similar opportunity refers to a business opportunity that has matching properties to the selected opportunity in one or more categories, which may be preselected. As used herein, the term property refers to one or more values of any category (e.g., field or related object) of an opportunity record. A matching property is where a numerical value or text string for the category of the respective opportunity records are the same, within a predetermined range (e.g. as a percentage or fixed), or have a specified overlap in the characters of the text string (e.g., XYZ and XYZ, inc. can be determined to be matching).

Next, mechanisms and methods for finding similar opportunities will be described with reference to example embodiments.

### System Overview

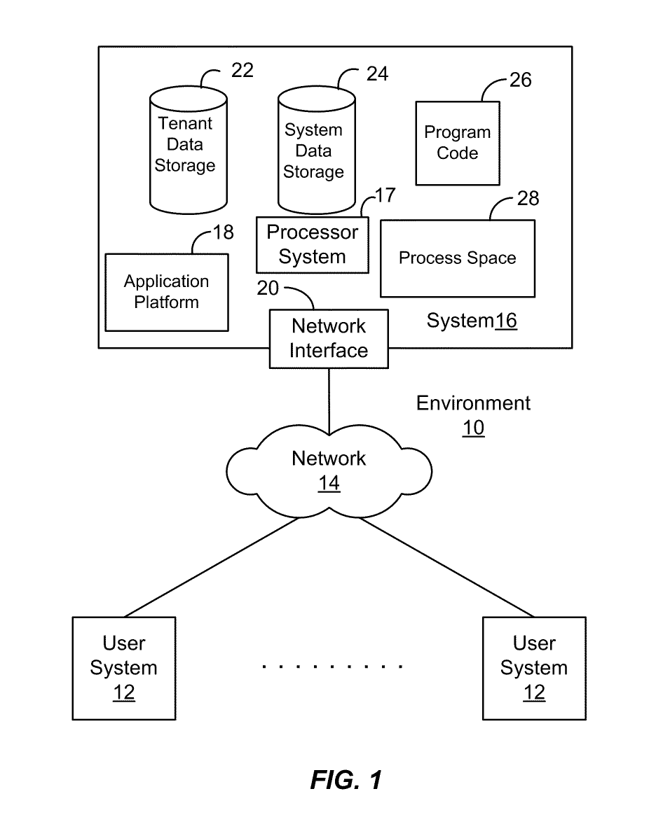

FIG. 1 illustrates a block diagram of an environment 10 wherein an on-demand database service might be used. Environment 10 may include user systems 12, network 14, system 16, processor system 17, application platform 18, network interface 20, tenant data storage 22, system data storage 24, program code 26, and process space 28. In other embodiments, environment 10 may not have all of the components listed and/or may have other elements instead of, or in addition to, those listed above.

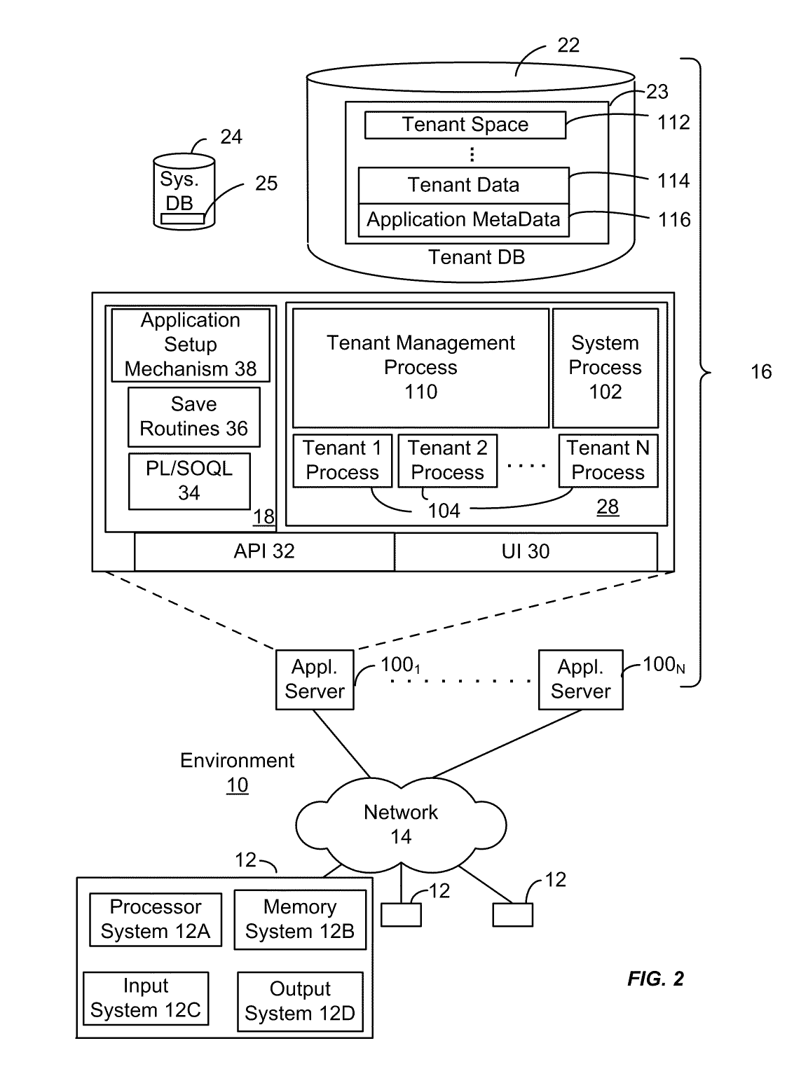

Environment 10 is an environment in which an on-demand database service exists. User system 12 may be any machine or system that is used by a user to access a database system. For example, any of user systems 12 can be a handheld computing device, a mobile phone, a laptop computer, a work station, and/or a network of computing devices. As illustrated in FIG. 1 (and in more detail in FIG. 2) user systems 12 might interact via a network 14 with an on-demand database service, which is system 16.

An on-demand database service, such as system 16, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 16” and “system 16” will be used interchangeably herein. A database image may include one or more database objects. A relational database management system (RDMS) or the equivalent may execute storage and retrieval of information against the database object(s). Application platform 18 may be a framework that allows the applications of system 16 to run, such as the hardware and/or software, e.g., the operating system. In an embodiment, on-demand database service 16 may include an application platform 18 that enables creation, managing and executing one or more applications developed by the provider of the on-demand database service, users accessing the on-demand database service via user systems 12, or third party application developers accessing the on-demand database service via user systems 12.

The users of user systems 12 may differ in their respective capacities, and the capacity of a particular user system 12 might be entirely determined by permissions (permission levels) for the current user. For example, where a salesperson is using a particular user system 12 to interact with system 16, that user system has the capacities allotted to that salesperson. However, while an administrator is using that user system to interact with system 16, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 14 is any network or combination of networks of devices that communicate with one another. For example, network 14 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the present invention might use are not so limited, although TCP/IP is a frequently implemented protocol.

User systems 12 might communicate with system 16 using TCP/IP and, at a higher network level, use other common Internet protocols to communicate, such as HTTP, FTP, AFS, WAP, etc. In an example where HTTP is used, user system 12 might include an HTTP client commonly referred to as a “browser” for sending and receiving HTTP messages to and from an HTTP server at system 16. Such an HTTP server might be implemented as the sole network interface between system 16 and network 14, but other techniques might be used as well or instead. In some implementations, the interface between system 16 and network 14 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 16, shown in FIG. 1, implements a web-based customer relationship management (CRM) system. For example, in one embodiment, system 16 includes application servers configured to implement and execute CRM software applications (application processes) as well as provide related data, code, forms, web pages and other information to and from user systems 12 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 16 implements applications other than, or in addition to, a CRM application. For example, system 16 may provide tenant access to multiple hosted (standard and custom) applications, including a CRM application. User (or third party developer) applications, which may or may not include CRM, may be supported by the application platform 18, which manages creation, storage of the applications into one or more database objects and executing of the applications in a virtual machine in the process space of the system 16.

One arrangement for elements or components of system 16 is shown in FIG. 1, including a network interface 20, application platform 18, tenant data storage 22 for tenant data 23, system data storage 24 for system data 25 accessible to system 16 and possibly multiple tenants, program code 26 for implementing various functions of system 16, and a process space 28 for executing MTS system processes and tenant-specific processes, such as running applications as part of an application hosting service. Additional processes that may execute on system 16 include database indexing processes.

Several elements in the system shown in FIG. 1 include conventional, well-known elements that are explained only briefly here. For example, each user system 12 could include a desktop personal computer, workstation, or mobile devices such as a laptop, PDA, cell phone, or any wireless access protocol (WAP) enabled device, or any other computing device capable of interfacing directly or indirectly to the Internet or other network connection. Examples of specific mobile devices include an iPhone™ and a Blackberry™. User system 12 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 12 to access, process and view information, pages and applications available to it from system 16 over network 14. Each user system 12 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 16 or other systems or servers. For example, the user interface device can be used to access data and applications hosted by system 16, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 12 and all of its components are operator configurable using applications, such as a browser, including computer code run using a central processing unit such as an Intel Pentium® processor or the like. Similarly, system 16 (and additional instances of an MTS, where more than one is present) and all of their components might be operator configurable using application(s) including computer code to run using a central processing unit such as processor system 17, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 16 to intercommunicate and to process web pages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments of the present invention can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 16 is configured to provide web pages, forms, applications, data and media content to user (client) systems 12 to support the access by user systems 12 as tenants of system 16. As such, system 16 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 2 also illustrates environment 10. However, in FIG. 2 elements or components of system 16 and various interconnections in an embodiment are further illustrated. FIG. 2 shows that user system 12 may include processor system 12A, memory system 12B, input system 12C, and output system 12D. FIG. 2 shows network 14 and system 16. FIG. 2 also shows that system 16 may include tenant data storage 22, tenant data 23, system data storage 24, system data 25, User Interface (UI) 30, Application Program Interface (API) 32, PL/SOQL 34, save routines 36, application setup mechanism 38, applications servers 100₁-100_{N}, system process space 102, tenant process spaces 104, tenant management process space 110, tenant storage area 112, user storage 114, and application metadata 116. In other embodiments, environment 10 may not have the same elements as those listed above and/or may have other elements instead of, or in addition to, those listed above.

User system 12, network 14, system 16, tenant data storage 22, and system data storage 24 were discussed above in FIG. 1. Regarding user system 12, processor system 12A may be any combination of one or more processors. Memory system 12B may be any combination of one or more memory devices, short term, and/or long term memory. Input system 12C may be any combination of input devices, such as one or more keyboards, mice, trackballs, scanners, cameras, and/or interfaces to networks. Output system 12D may be any combination of output devices, such as one or more monitors, printers, and/or interfaces to networks. As shown by FIG. 2, system 16 may include a network interface 20 (of FIG. 1) implemented as a set of HTTP application servers 100, an application platform 18, tenant data storage 22, and system data storage 24. Also shown is system process space 102, including individual tenant process spaces 104 and a tenant management process space 110. Each application server 100 may be configured to tenant data storage 22 and the tenant data 23 therein, and system data storage 24 and the system data 25 therein to serve requests of user systems 12. The tenant data 23 might be divided into individual tenant storage areas 112, which can be either a physical arrangement and/or a logical arrangement of data. Within each tenant storage area 112, user storage 114 and application metadata 116 might be similarly allocated for each user. For example, a copy of a user's most recently used (MRU) items might be stored to user storage 114. Similarly, a copy of MRU items for an entire organization that is a tenant might be stored to tenant storage area 112. A UI 30 provides a user interface and an API 32 provides an application programmer interface to system 16 resident processes to users and/or developers at user systems 12. The tenant data and the system data may be stored in various databases, such as one or more Oracle™ databases.

Application platform 18 includes an application setup mechanism 38 that supports application developers' creation and management of applications, which may be saved as metadata into tenant data storage 22 by save routines 36 for execution by subscribers as one or more tenant process spaces 104 managed by tenant management process 110 for example. Invocations to such applications may be coded using PL/SOQL 34 that provides a programming language style interface extension to API 32. A detailed description of some PL/SOQL language embodiments is discussed in commonly owned co-pending U.S. Provisional Patent Application 60/828,192 entitled, PROGRAMMING LANGUAGE METHOD AND SYSTEM FOR EXTENDING APIS TO EXECUTE IN CONJUNCTION WITH DATABASE APIS, by Craig Weissman, filed Oct. 4, 2006, which is incorporated in its entirety herein for all purposes. Invocations to applications may be detected by one or more system processes, which manages retrieving application metadata 116 for the subscriber making the invocation and executing the metadata as an application in a virtual machine.

Each application server 100 may be communicably coupled to database systems, e.g., having access to system data 25 and tenant data 23, via a different network connection. For example, one application server 100₁ might be coupled via the network 14 (e.g., the Internet), another application server 100_{N-1} might be coupled via a direct network link, and another application server 100_{N} might be coupled by yet a different network connection. Transfer Control Protocol and Internet Protocol (TCP/IP) are typical protocols for communicating between application servers 100 and the database system. However, it will be apparent to one skilled in the art that other transport protocols may be used to optimize the system depending on the network interconnect used.

In certain embodiments, each application server 100 is configured to handle requests for any user associated with any organization that is a tenant. Because it is desirable to be able to add and remove application servers from the server pool at any time for any reason, there is preferably no server affinity for a user and/or organization to a specific application server 100. In one embodiment, therefore, an interface system implementing a load balancing function (e.g., an F5 Big-IP load balancer) is communicably coupled between the application servers 100 and the user systems 12 to distribute requests to the application servers 100. In one embodiment, the load balancer uses a least connections algorithm to route user requests to the application servers 100. Other examples of load balancing algorithms, such as round robin and observed response time, also can be used. For example, in certain embodiments, three consecutive requests from the same user could hit three different application servers 100, and three requests from different users could hit the same application server 100. In this manner, system 16 is multi-tenant, wherein system 16 handles storage of, and access to, different objects, data and applications across disparate users and organizations.

As an example of storage, one tenant might be a company that employs a sales force where each salesperson uses system 16 to manage their sales process. Thus, a user might maintain contact data, leads data, customer follow-up data, performance data, goals and progress data, etc., all applicable to that user's personal sales process (e.g., in tenant data storage 22). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 16 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant-specific data, system 16 might also maintain system level data usable by multiple tenants or other data. Such system level data might include industry reports, news, postings, and the like that are sharable among tenants.

In certain embodiments, user systems 12 (which may be client systems) communicate with application servers 100 to request and update system-level and tenant-level data from system 16 that may require sending one or more queries to tenant data storage 22 and/or system data storage 24. System 16 (e.g., an application server 100 in system 16) automatically generates one or more SQL statements (e.g., one or more SQL queries) that are designed to access the desired information. System data storage 24 may generate query plans to access the requested data from the database.

A table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system.

### Finding Similar Opportunities

In a large organization, a user can be at a loss for guidance on how to close a business opportunity. Embodiments can allow a user to identify and reach out to other salespersons who may have closed similar deals like one that the user is working on. Based on a list of fields and related records, such as name, account, partners, and products, the user can see a list of opportunities that match on one or more of those fields or related records or other properties. The user can then find details of the similar opportunities, and contact the owner of those opportunities if he/she desires. The user can also bookmark one or more opportunities from the list of similar opportunities.

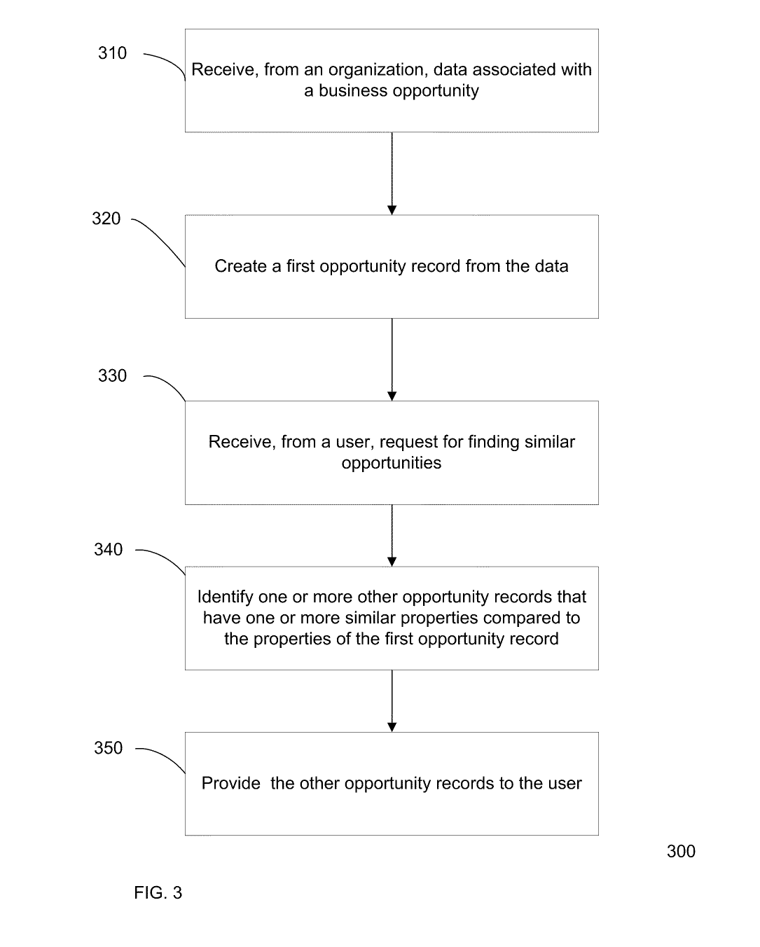

FIG. 3 is a flowchart of a method 300 of identifying a business opportunity according to an embodiment of the present invention. An ability for users of an organization to find similar opportunities can be enabled by an administrator of the organization. The process is typically initiated when a user of an organization has a business opportunity to work on. An opportunity object is created to represent that business opportunity. An opportunity object may be created by either a user or an administrator depends on business settings.

In step 310, a database system (e.g. system 16) receives data associated with a business opportunity from an organization. The data may include information associated with the opportunity, such as an account, the owner, a closing date, an amount, type, ID number, name, and division of the business entity, etc. In one embodiment, a user provides these data to the database system through a user interface.

In step 320, a first opportunity record that includes a plurality of fields is created in a database of the database system. A field contains information associated with the business opportunity. Fields of the opportunity record hold the values of the data received in step 310. An opportunity may have standard fields, fields that are defined and provided by the system. An opportunity may also have custom fields, fields that may be customized for a particular organization, or for a particular department. In one embodiment, a table is created in the database to store business opportunity records with columns representing fields of an opportunity. For example, an opportunity table with columns account, owner, name, closing date, ID number, department id, partner ID, etc. may be created in the database to receive data for business opportunities. After receiving the data, the database system creates an opportunity record in the database. The opportunity record has a set of properties that represent the data received associated with the opportunity.

The data received by the database system may also include a list of other objects or text strings that are related to the opportunity, such as competitors, partners, and products, etc. An object that can be related to the opportunity object is also referred to as a related list. In one embodiment, the relationship between the opportunity record and a list of other related records are also established during the creation of the opportunity record. All of these data, fields and related lists, may be stored in their respective categories (e.g. name, competitor, . . . ) as being associated with an opportunity object.

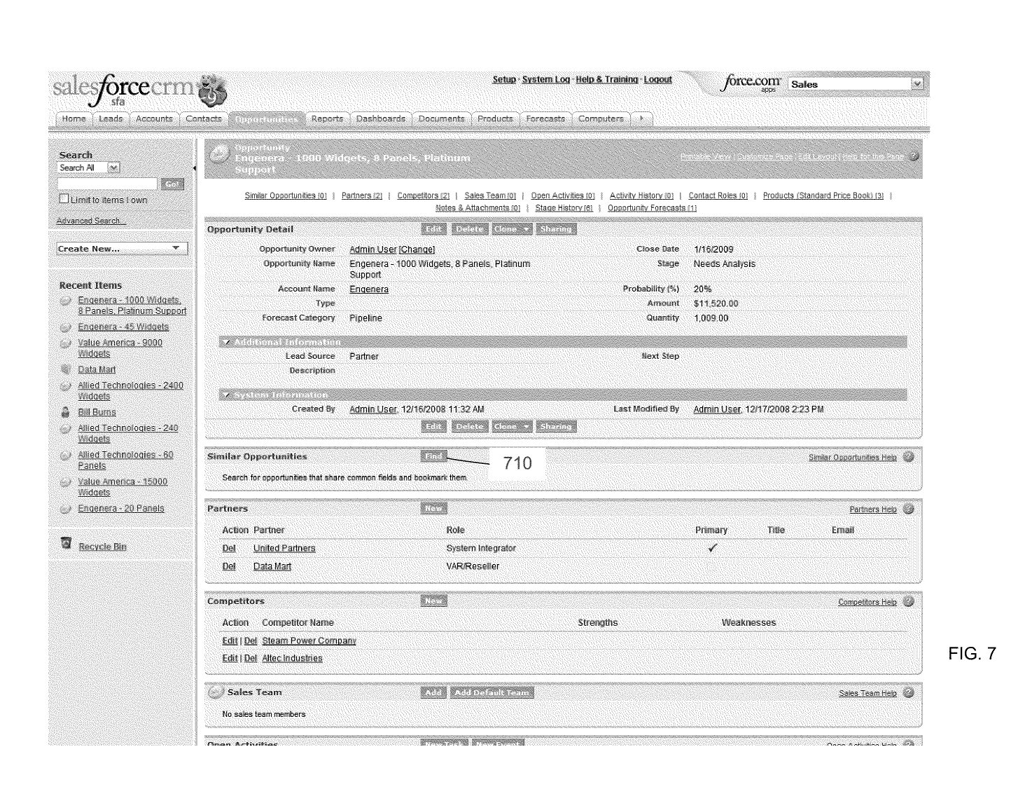

In step 330, the database system receives a request from a user of the organization to find other business opportunities similar to the business opportunity the user is working on. In one embodiment, a user can send the request to the database system by clicking on a “Find” button under Similar Opportunities, as shown in 710 of FIG. 7. The database system receives the request and processes the request accordingly.

In step 340, the database system identifies one or more opportunity records in the database as being similar to the first opportunity record. Opportunity records in the database are compared with respect to values in a set of properties selected as the matching categories. Selection of matching categories will be discussed in details later in this specification. In one embodiment, one or more fields of opportunity records are compared to a set of selected fields of the first opportunity record. In another embodiment, one or more related lists of opportunity records are matched against one or more selected related lists of the first opportunity record. Any combination of fields, related records, and other properties can be compared.

In one embodiment, the identification involves a search of an opportunity records and an identification of which ones are most similar, e.g., which ones match on the most properties. In one embodiment, for each of the fields that match, the total relevancy/similarity is incremented by 1. However, for related lists, even if multiple records of a certain object type match, the total relevance/similarity is counted the same as for one record of that object type matching.

In step 350, these opportunity objects are provided to the user so that the user may analyze the opportunity objects and reach out to the owners of those opportunities interested to the user. The opportunities may be provided as a list of similar records. Each opportunity record of the list has at least one field or related list similar to the first opportunity object.

### Configuring an Opportunity for Finding Similar Opportunities

As discussed above, search for similar opportunities of an opportunity is conducted based on a set of fields and related lists selected to match against. The set of fields or related lists of an opportunity is also called matching categories, or matching criteria. The matching categories may be selected for an opportunity object prior to finding similar opportunities for the opportunity. In one embodiment of the invention, an administrator of a tenant makes default selections of matching criteria for finding similar opportunities for an opportunity object.

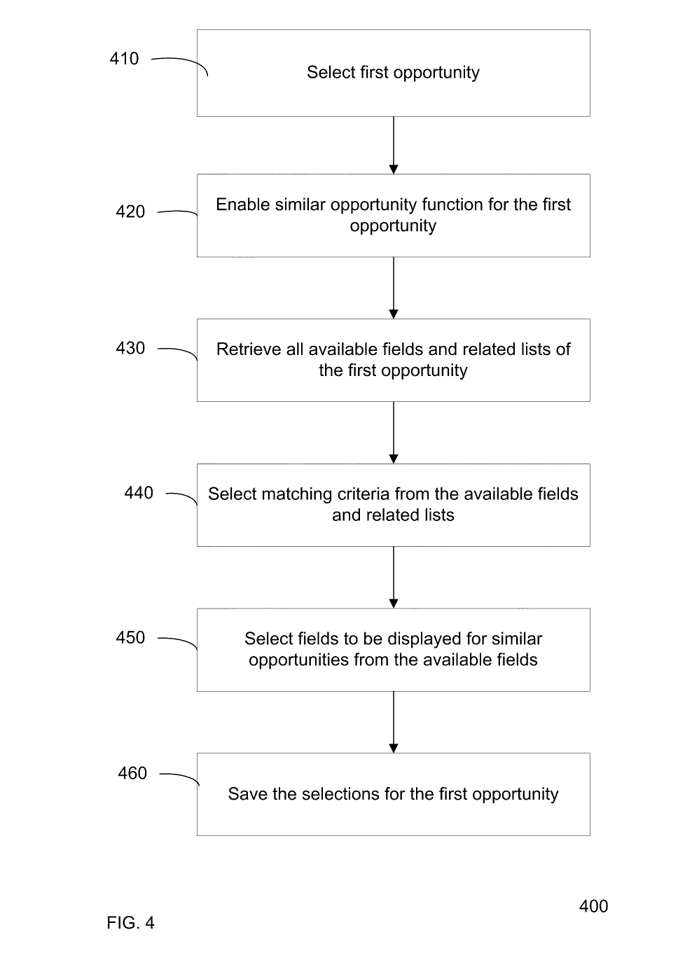

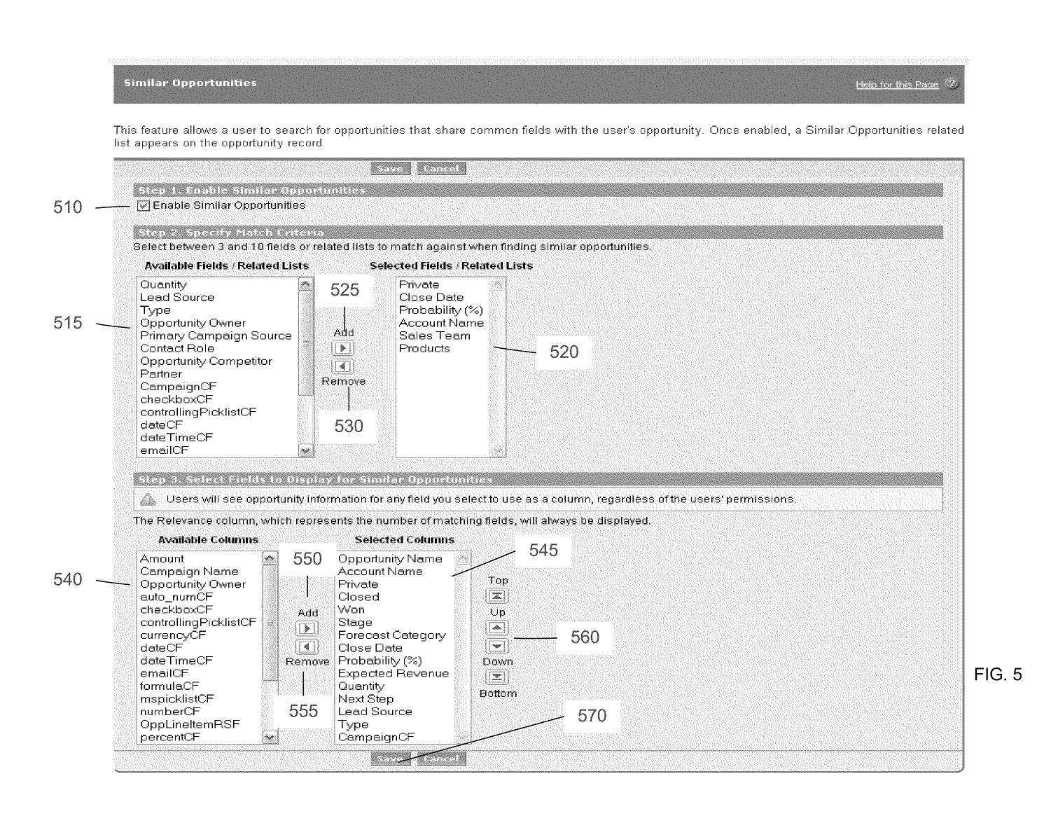

FIG. 4 is a flowchart of a method 400 of customizing features for the identification of similar opportunities (e.g. as can be configured by an administrator) according to embodiments of the present invention. FIG. 5 shows a screenshot of an admin page that allows an administrator to configure an opportunity object according to an embodiment of the present invention.

In step 410, a first opportunity object is selected by an administrator of an organization that is a subscriber of an on-demand database service. The selection may be received by an on-demand database service as described herein.

In step 420, an administrator enables similar opportunity function for an opportunity object. In one embodiment of the invention, an admin page allows an administrator to enable or disable the functionality that allows a user to find similar opportunities like the current business opportunity. As shown in FIG. 5, the administrator checks checkbox 510 to enable this functionality. The administrator can also uncheck the checkbox 510 for an opportunity object to disable this functionality.

Once the similar opportunity function is enabled, a list of similar opportunity related lists appear on the opportunity record. In one embodiment, the configuration page allows the administrator to select which opportunity layouts the similar opportunities related list appears on (i.e. which class of users can use this option).

In step 430, the database system retrieves all available fields of the opportunity object from the database. All object types that can be related to the opportunity object are also retrieved from the database. In one embodiment, the available fields and related lists are combined and displayed in a list box for the administrator to select. As shown in FIG. 5 in List Box 515, the available fields/related lists include fields such as quality, type, opportunity owner, etc. The available fields/related lists in List Box 515 also include related lists such as partner, opportunity competitor, etc.

In step 440, the administrator selects matching categories for finding similar opportunities. In one embodiment, the administrator selects one or more fields or related lists from the available fields and related lists as the matching categories for finding similar opportunities. For example, as shown in FIG. 5 in List Box 520, the administrator selects “private”, “closed date”, “probability(%)”, “account name”, “sales team” and “products” as the matching criteria. To make a selection, an administrator first selects one or more categories from the available fields and related lists in List Box 515, and then the administrator clicks Add button 525, the selected categories will disappear from List Box 515 and show up in List Box 520. The administrator may also remove one or more fields or related lists from the selected fields or related lists by selecting those categories to be removed in List Box 520, and clicking Remove button 530. The categories selected for removal will be moved from List Box 520 to List Box 515.

According to one embodiment of the invention, the search for similar opportunities is run in system mode, therefore the search does not require sharing tables. As a result, the search is to match against all fields that have matching values to the user's opportunity record based on field equality regardless of the user's access privileges to those fields. In another words, the data in these categories may be accessible independent of sharing and field level security, i.e. whether a user has access rights to view the data via other mechanisms.

The categories selected by the administrator may be used as a default for all opportunity objects. In one embodiment, a user may also change the selections of matching categories. In this embodiment, a section of user page will allow the user to change the default matching categories selected by the administrator.

In one embodiment, an administrator can select between 3 and 10 fields or related lists for the matching criteria.

According to one embodiment, the administrator specifies whether to allow restricting the results to Closed Opportunities only (e.g. opportunities that have been won). In one embodiment, the administrator also specifies a default date range for finding similar opportunities.

In step 450, the administrator selects columns to be displayed from a set of available columns for the opportunity object. As shown in FIG. 5, available columns are listed in List Box 540, selected columns are listed in List Box 545. To make a selection, the administrator first selects one or more columns from the available columns in List Box 540. The administrator can then click Add button 550, the selected columns will disappear from List Box 540 and show up in List Box 545. The administrator may rearrange the appearance of the selected columns by using the set of action buttons 560. The administrator may also remove one or more selected columns from the selected column lists by selecting those columns to be removed in List Box 545, and clicking Remove button 555. The columns selected for removal will be moved from List Box 545 to List Box 540.

As noted above, the administrator selects one or more fields as matching criteria from all available fields regardless whether the user has privilege to access those fields or not. However, the administrator may specify a subset of fields out of all available fields as the only columns that will be displayed for the similar opportunities to the user. Only those fields selected by the administrator for display will be visible when search results are displayed to the user, other fields of the opportunity objects may be kept hidden from the user. The user will see opportunity information for any field the administrator select to use as display columns, regardless of the user's permissions. The Relevancy column, which represents the number of matching properties, will always be displayed.

In step 460, the administrator saves the configuration of the opportunity object. As shown in FIG. 5, Save button 570 saves the configurations into the database. In one embodiment of the invention, the configurations are saved into a listFilter in the database with equality matching dummy values. These dummy values are substituted with values in corresponding categories of the opportunity record when a query for finding similar opportunity is generated.

In one embodiment of the invention, configuration properties of an opportunity may also be managed by a user. An administrator of the tenant may give a user enough privilege to manage the configuration properties.

### Searching Similar Opportunities

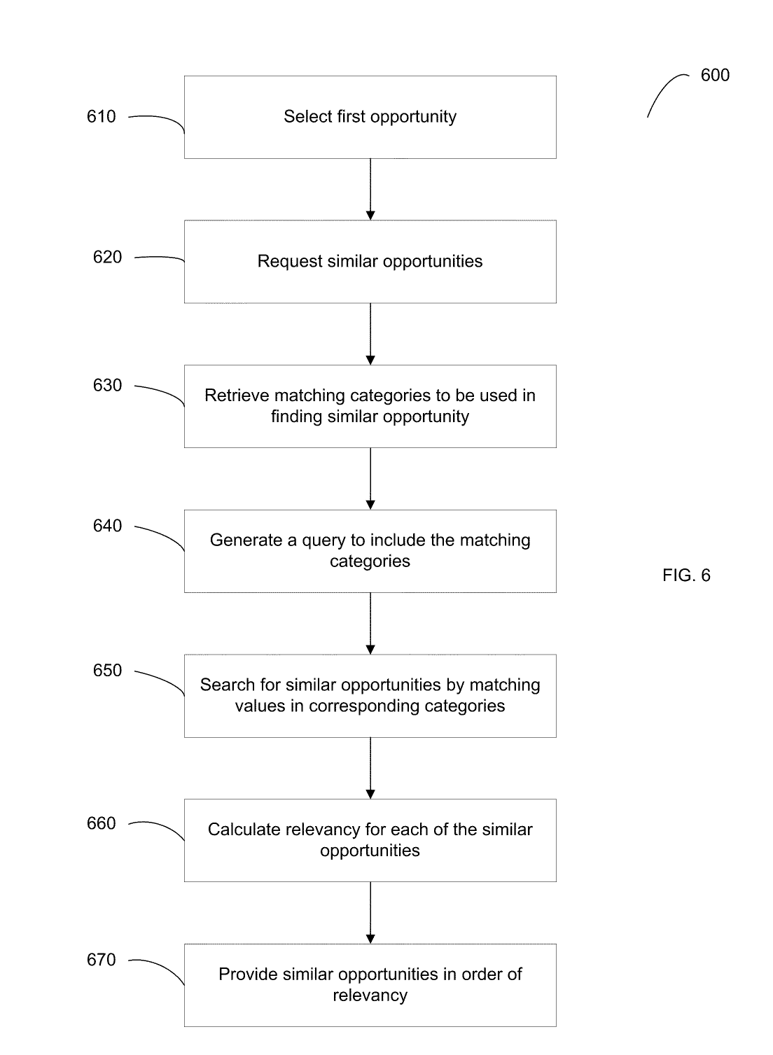

FIG. 6 is a flowchart of a method 600 of providing a similar opportunity according to an embodiment of the present invention. If the similar opportunity functionality is enabled by the administrator of the organization, a user, e.g. a salesperson of an organization may be able to find similar opportunities of an opportunity.

In step 610, a first opportunity is selected by a user. The selection may occur in any number of ways. In one embodiment, a user may select an opportunity from a list of opportunities that the user is working on.

In step 620, a user makes a request to find opportunities similar to the first opportunity. Such a request may be submitted by clicking a find button near or in a similar opportunities list, which is shown on a page of a display of the first opportunity. In one embodiment, an option (e.g. a new node on an action-item tree) called Similar Opportunities is added under an opportunity object. FIG. 7 shows a screenshot of an opportunity object with a similar opportunities option and a find button according to an embodiment of the present invention. As shown in FIG. 7, a user clicks on Find button 710 will start the search process.

In step 630, the matching categories for the first opportunity object are retrieved from the database. As discussed above, the matching categories are selected by an administrator for finding opportunities with matching values to the first opportunity record. In one embodiment, a user may modify the default selection of the matching categories of an opportunity object made by an administrator.

In step 640, a query is generated to search for one or more opportunities similar to the first opportunities based on the matching categories retrieved. In one embodiment, for finding similar opportunities for a particular opportunity, filters are used for matching similar fields on the opportunity. In one aspect, the filter is not visible to the end users and will bypass sharing. When the user clicks on Find button 710 from the Similar Opportunities, the matching criteria field values from the opportunity record are injected into a filter SQL and run. In another aspect, the filter criteria may be OR'd together.

In step 650, other opportunities are searched to find similar opportunities by finding matching (e.g. similar) values in corresponding categories. The similar opportunities have category data that are similar to the data in corresponding categories of the first opportunity. The search is conducted based on the fields and related lists selected during configuration phase. The similarity may be an exact match of values or values that are within a threshold (e.g. a specified %) of the value in the first opportunity object. For example, certain fields may have a same value.

In one embodiment, the search initially retrieves all the opportunities that are closed, won and not deleted within the date filtering period. Those opportunities are then passed to a search results container which keeps the results organized and indexed in many different ways. Each opportunity object in the result container can have the following properties: relevancy, bit string for matching opportunity fields, matching related lists and matching bit map.

Next we get the relevancy for opportunity fields set by the admin on the matching criteria. Each opportunity field matching criteria is given a number that is a power of 2 (1, 2, 4, 8, and so on). The SQL query returns the opportunities that match on at least one opportunity field matching criteria and a number (which is the sum of powers of 2 for the criteria that match). Fields matched for that opportunity can be derived from the number returned. The bit string for matching opportunity fields property of each opportunity object in the result container is updated with the new information.

Then, for each of the opportunities collected in the result container, a match is run for each of related lists in the matching categories. In one embodiment, the query for each of the related lists is on the same line. It's a self join on the specific table for that related list criteria. The results from the query are opportunities that match at least one related list object with the first opportunity. For each related list query results, we find the relevant object in the search results container and update the matching related list to identify that it matches a particular related list. However, if more than one item for the result opportunity matches the first opportunity, the related list match criteria is still only recorded once in the results object (Matching related lists). Each unique value that is matched is stored for bit map calculation.

In step 660, relevancy for each of similar opportunities is calculated. In one embodiment, the amount of similarity for each category is measured, and the total similarity across all categories is measured. For example, a perfect match may provide a “1” while other matches provide a value of less than “1”, with the total number of matches being added. In one embodiment, only exact matches are used. Range matches, substring matches, and wildcard matches may be used (potentially with less than 1 relevancy point allotted). In one embodiment, the total relevancy for a result similar opportunity is the sum of number of 1's in the Bit String for matching opportunity fields and how many Matching related lists matched. The internal data structure in the results container keeps the results sorted by relevancy at all times.

In one embodiment, this relevancy value is taken as the final relevancy value. Note that all categories may be used. In another embodiment, this relevancy value is an intermediate relevancy value that includes only fields, and not related lists.

For example, from the opportunities returned by the filter query, each of the related lists criteria is matched against. In one aspect, there is a separate query for each of the related lists selected against the opportunities returned by the initial match on opportunity fields. In one embodiment, there may be a max number of related lists, e.g., 4. Relevancy calculation and sorting for opportunity fields take place in the database. For each of the subsequent queries (related lists), the relevancy of a particular row is incremented while merging the result set. The resulting result sets will be merged and passed on to the JSONSerializer and further passed on to the Ext js DataStore.

In one embodiment, the opportunities are limited with certain criteria initially to alleviate performance concerns due to no limiting/restricting criteria for matching (e.g., all the criteria being inclusive OR's). The relevancy is then calculated based on how many fields are in common. The following filtering criteria may be used to restrict the number of opportunities returned: Is Opportunity Closed. (New Index on “Closed” field); Closed within a date range. (New Index on Close Date); and Opportunity Amount with a certain % of the matched against Opportunity.

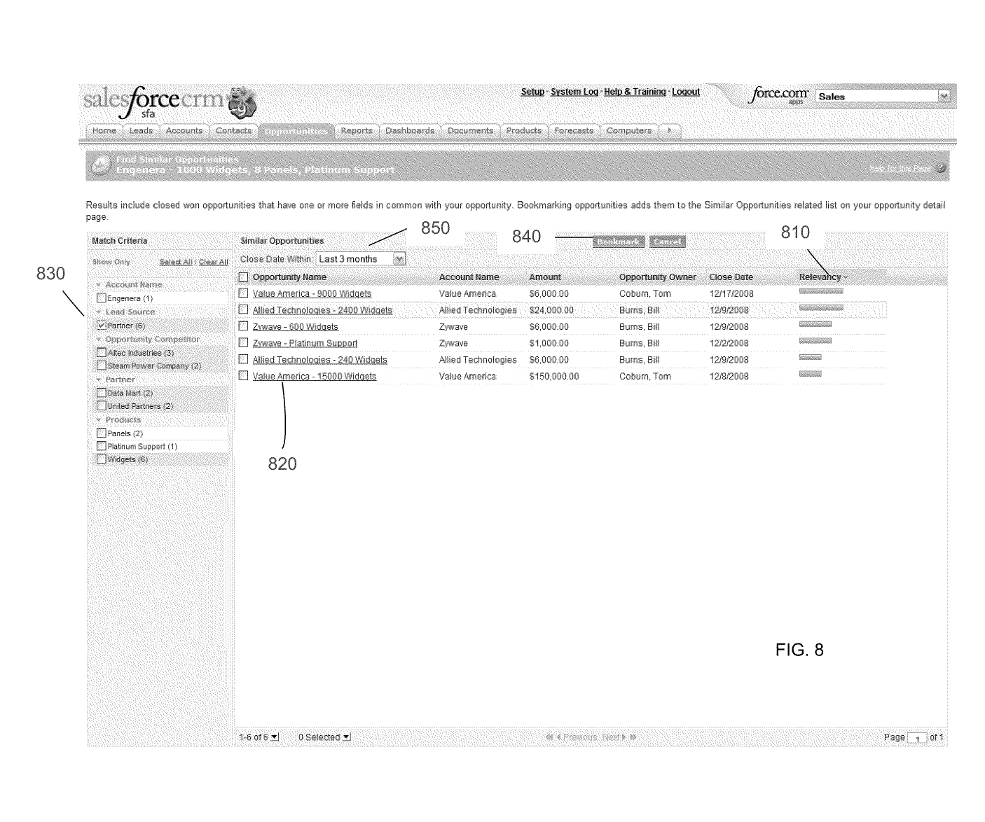

Referring back to FIG. 6, in step 670 the similar opportunities are provided to the user, e.g., as shown in FIG. 8. The columns selected for display by an admin during the configuration phase now are displayed to the user. For example, in FIG. 8, columns “Opportunity Name”, “Account Name”, “Amount”, “Opportunity Owner”, “Close Date” and “Relevancy” are visible. In one embodiment, the Relevancy column 810 is always visible. The similar opportunities are presented to the user in the order of relevancy. The opportunity with the highest relevancy is at the top of the list. In one embodiment, only similar opportunities with a relevancy greater than a threshold are provided.

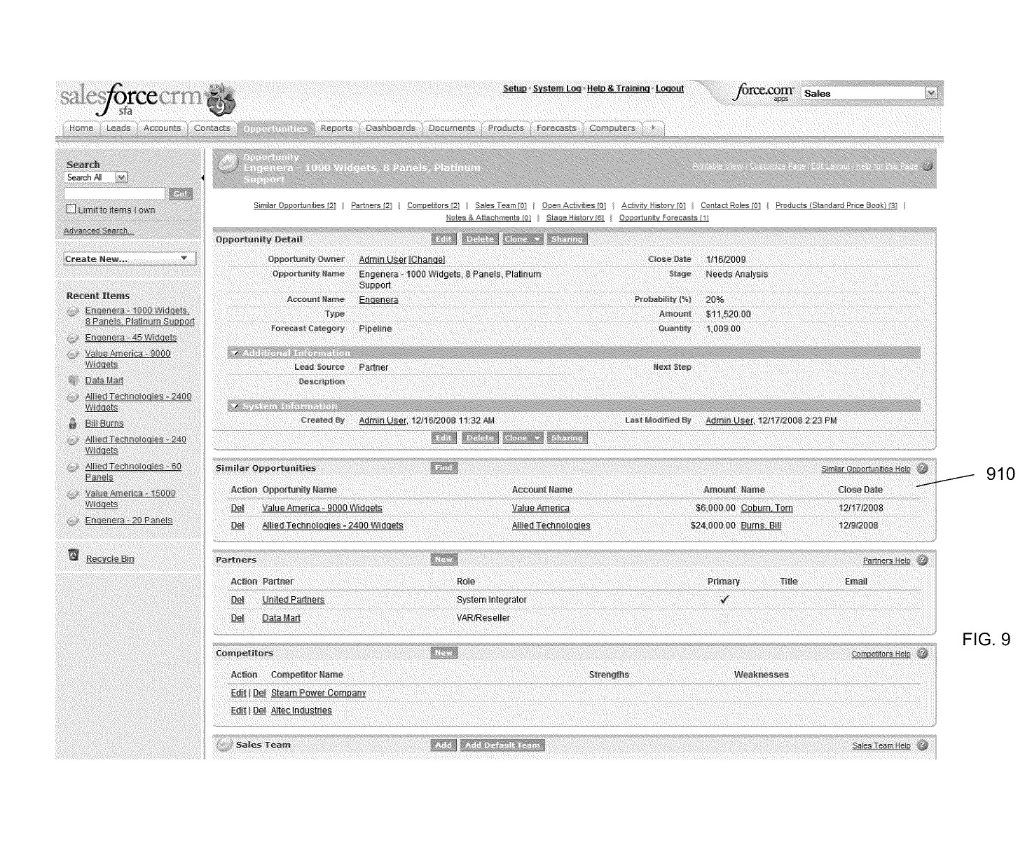

As shown in FIG. 8, each of the similar opportunities provides a link to the detail page of that opportunity. In FIG. 8, the link 820 is underlined. If the permission allows, click on the link will go to the detail page of that opportunity object, as shown in FIG. 9. In the case that the user does not have permissions to access the opportunity object, according to one embodiment of the invention, a new page will popup displaying the contact information of the owner of that similar opportunity object. The user may then contact the owner for further information if he/she needs to. In one embodiment, the popup page allows the user to email the owner of that opportunity.

In one embodiment, the matching bit maps are created for each of the resulting similar opportunities. There are two bit maps which are orthogonal to each other. One goes from match criteria to opportunities and the other goes from opportunities to matching criteria. In one embodiment, the matching bit map to the matching criteria values and the matching criteria values to the matching bit map are calculated for each of the opportunity of the top 300 relevant opportunities from the results container.

The results, the matching fields, opportunity fields and related list values for the parent opportunity, and the two bit maps created above are then JSON'd and sent to the user.

FIG. 8 shows a left hand side panel 830 that displays the categories used for the matching and how many opportunities match a particular category. In one embodiment, when a cursor hovers over an opportunity, the categories that are matched are then highlighted. In another embodiment, checking a field-value on the left panel highlights all the search results that share that field-value.

In one embodiment, the results page consists of an ext js Grid view that displays the returning results to the user. The whole result set is sent the client, so that further actions initiated by the user will all be handled through the client side. Even though the whole set is returned to the user, the grid may be configured to only display a number of records initially so that the browser does not need to render the entire set on load. In one embodiment, the first 20 records are displayed to the user initially. In one embodiment, the result displayed is limited those opportunities whose close date falling within a certain period. For example, as shown in FIG. 8 item 850, the default time is set to last 3 months. The user can choose different times. Once a new time is selected, a new query is executed with the new selection, and result is displayed to the user.

As described above, the left hand side panel 830 of the result page may be a new page component that interacts with the list of similar opportunities. In one embodiment, the left hand side panel 830 contains a number of events attached to checkboxes that filter the returned data set locally. The checkboxes represent category values that are extracted from the parent opportunity. The user will be able to filter by these values. When a cursor hovers over an opportunity shown in the list, and that opportunity has the same values as the filters on the left side, the filters/checkboxes will be highlighted to indicate this match. In one embodiment, hovering the cursor on the relevancy displays how many categories of this opportunity are matched with those categories of the user's own opportunity (sometimes called parent opportunity).

In one embodiment, to speed up the calculations needed during the highlighting and filtering, most of the rows and categories are tagged with attributes that represent what that row/category means. When the user mouses over or checks the box, the client side code can just run through each row or category and perform the action for the ones with the given attribute rather than trying to compare values on the fly.

As noted above, a user may select similar opportunities to save (e.g. bookmark). As shown in FIG. 8, a user can select one or more similar opportunities from the result page and then click Bookmark button 840. Once bookmarked, a user can get back to the saved similar opportunities without having to search them again. As shown in FIG. 9 item 910, there are two similar opportunities bookmarked for this opportunity. A user may also delete one or more opportunities from the bookmark. In embodiment, the bookmarked similar opportunities can be viewed by other users as long as the other users have privilege to access the parent opportunity.

In one embodiment, the database system employs a separate object to keep track of the bookmarks. This object will be used to store a pointer from opportunity to opportunity. In one embodiment, the bookmark object would be extensible to include other objects. There will be a new related list on Opportunity that lists the bookmarks that opportunity has. The related list will show details from the other opportunity and will bypass all sharing. In one embodiment, the bookmark object has these columns: Id, From, To, IsDeleted, CreatedDate, CreatedBy, LastModifiedDate, LastModifiedBy, and SystemModstamp.

Although embodiments have been described in relation to finding a similar business opportunity, embodiments can be used for finding other similar objects.

The specific details of the specific aspects of the present invention may be combined in any suitable manner without departing from the spirit and scope of embodiments of the invention. However, other embodiments of the invention may be directed to specific embodiments relating to each individual aspects, or specific combinations of these individual aspects.

It should be understood that the present invention as described above can be implemented in the form of control logic using hardware and/or using computer software in a modular or integrated manner. Based on the disclosure and teachings provided herein, a person of ordinary skill in the art will know and appreciate other ways and/or methods to implement the present invention using hardware and a combination of hardware and software

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer program product (e.g. a hard drive or an entire computer system), and may be present on or within different computer program products within a system or network. A computer system may include a monitor, printer, or other suitable display for providing any of the results mentioned herein to a user.

While the invention has been described by way of example and in terms of the specific embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A computer-implemented method of identifying a similar opportunity, the method comprising:
a database system receiving, from an organization, data associated with a first business opportunity;
creating, in a database of the database system, a first opportunity record from the data associated with the business opportunity, the first opportunity record having a plurality of properties defined in the database system;
the database system receiving, from a user of the organization, a request for business opportunities similar to the first business opportunity;
the database system identifying one or more similar opportunity records that have one or more matching properties compared to the properties of the first opportunity record; and
providing, to the user, the one or more similar opportunity records.

2. The method of claim 1, wherein the plurality of properties of the first opportunity record are organized into a plurality of categories, wherein the categories include database fields of the first opportunity record, and wherein the fields include one or more selected from the group of: amount, type, ID number, name, and closing date.

3. The method of claim 2, wherein the categories include object types of records that are related to the first opportunity record.

4. The method of claim 1, wherein the first opportunity record is an instance of an opportunity object, further comprising:
prior to receiving the data associated with the first business opportunity and crating the first opportunity record, receiving a configuration of categories of properties to be used in identifying similar opportunity records for the opportunity object.

5. The method of claim 4, wherein the configurations of the first opportunity object are conducted by an administrator of the organization.

6. The method of claim 4, wherein receiving a configuration of categories of properties to be used in identifying similar opportunity records for the opportunity object includes:
receiving a first list of selected categories for the opportunity object, wherein an instance of an opportunity object has one or more properties for each category, and
wherein identifying one or more similar opportunity records uses the properties of the selected categories for determining the one or more matching properties.

7. The method of claim 6, further comprising:
receiving a second list of selected categories, wherein providing the one or more similar opportunity records includes displaying only the properties in the second list of selected categories for the identified one or more similar opportunity records.

8. The method of claim 6, wherein providing, to the user, the one or more similar opportunity records includes:
displaying the first list of selected categories along with the matching properties; and
when a selection of a similar opportunity record is received, highlighting the matching properties of the selected similar opportunity record.

9. The method of claim 6, further comprising:
after providing, to the user, the one or more similar opportunity records, the database system receiving from the user a selection of one or more categories to be used in a subsequent identification of similar opportunity records for the first opportunity record, wherein the one or more user-selected categories are a subset of the first list of selected categories for the opportunity object.

10. The method of claim 9, wherein providing, to the user, the one or more similar opportunity records includes:
displaying the first list of selected categories along with the matching properties;
receiving a selection of a subset of the matching properties; and
identifying a subset of the similar opportunity records that match the selected subset of matching properties.

11. The method of claim 1, wherein the plurality of properties of the first opportunity record are organized into a plurality of categories, and wherein identifying one or more similar opportunities includes:
retrieving, from the database, at least one of the properties of one or more of the categories of the first opportunity record;
generating a query that includes each of the retrieved properties along with the corresponding category;
determining whether any of the properties for each corresponding category has a matching property with another opportunity record; and
if a category of another opportunity record has a matching property, then increasing a relevancy value for that another opportunity record,
wherein providing, to the user, the one or more similar opportunity records includes displaying the relevancy value for each similar opportunity record.

12. The method of claim 11, wherein the increase of the relevancy value for a category is proportional to the number of matching properties for the category.

13. The method of claim 11, wherein only the similar opportunity records having a relevancy value greater than a threshold are provided to the user.

14. The method of claim 1, further comprising:
the database system receiving from the user a selection of one or more of the similar opportunities to bookmark; and
the database system storing an association the bookmarked similar opportunity to a profile of the user.

15. A computer program product comprising a tangible computer readable medium storing a plurality of instructions for controlling one or more processors of a database system to perform an operation for identifying a similar opportunity, the instructions comprising:
the database system receiving, from an organization, data associated with a first business opportunity;
creating, in a database of the database system, a first opportunity record from the data associated with the business opportunity, the first opportunity record having a plurality of properties defined in the database system;
the database system receiving, from a user of the organization, a request for business opportunities similar to the first business opportunity;
the database system identifying one or more similar opportunity records that have one or more matching properties compared to the properties of the first opportunity record; and
providing, to the user, the one or more similar opportunity records.

16. A database system comprising:
a database that stores database objects for a plurality of organizations; and
one or more processors configured to:
receive, from an organization, data associated with a first business opportunity;
create, in the database, a first opportunity record from the data associated with the business opportunity, the first opportunity record having a plurality of properties defined in the database system;
receive, from a user of the organization, a request for business opportunities similar to the first business opportunity;
identify one or more similar opportunity records that have one or more matching properties compared to the properties of the first opportunity record; and
provide, to the user, the one or more similar opportunity records.
